(19) United States
(12) Patent Application Publication
(10) Pub. No.: US 2004/0055558 A1
(43) Pub. Date: Mar. 25, 2004

(54) System and method for vehicle idle reduction

(76) Inventor: Jay McElroy, Cuba, AL (US)

Correspondence Address: Brian D. Walker, Jenkens & Gilchrist, P.C., Suite 3200, 1445 Ross Avenue, Dallas, TX, 75202-2799, US

(21) Appl. No.: 10/671,296

(22) Filed: Sep. 25, 2003

Related U.S. Application Data
(60) Provisional application No. 60/413,307, filed on Sep. 25, 2002.

(51) Int. Cl. F02N 17/00

(52) U.S. Cl. 123/198 DC; 123/179.4

(57) ABSTRACT

A system and method for reducing idle times of a vehicle wherein circuitry determines whether a vehicle is occupied and upon detection that the vehicle is occupied, disabling a timer that generates a signal to shut off an engine of the vehicle.

### RELATED APPLICATION(S)

This application claims priority from and incorporates herein by reference the entire disclosure of U.S. Provisional Application Serial No. 60/413,307 filed Sep. 25, 2002.

### TECHNICAL FIELD

The present invention relates to the operation of motorized vehicles, and more particularly, to a system and method for reducing the amount of idling time by a motorized vehicle.

### BACKGROUND OF THE INVENTION

The operation of internal combustion engine vehicles by private individuals and in the transportation industry many times involves the vehicle sitting still with its internal combustion engine idling. Sometimes this is necessary because the vehicle is only temporarily stopped and it is not cost effective or efficient to turn off the internal combustion engine every time the vehicle comes to a stop. Idling is also necessary when the vehicle is occupied and stopped to insure the comfort of the driver while he/she sleeps, relaxes or works with the stopped vehicle. However, at other times the internal combustion engine of a vehicle may be left idling when the vehicle is stopped and unoccupied due to forgetfulness, inattention, laziness on the part of the driver or they desire to maintain climate control even if they are planning to leave the vehicle for extended periods of time. Idling is a major problem within the transportation industry because it burns fuel, thus increasing costs of operation of the vehicle and polluting the environment. This problem can be particularly serious in areas of the transportation industry where drivers may not turn off their trucks from the time they leave home until they return. Thus, during the operation cycle the vehicle is continuously idling during meals, fueling, loading and unloading of the vehicle. This unnecessary burning of fuel while the vehicle is stopped and unoccupied is a problem within the transportation industry where high fuel prices and low margins combine to provide a need for limiting costs and especially for limiting fuel costs in any way that may be feasible. Additionally, the need for such devices may become more necessary as governmental/EPA studies begin to focus on the health concerns rising from, for example, diesel truck emission. EPA studies have revealed that here are many life threatening health hazards associated with diesel emissions and has set a goal of seeking new technologies to reduce idling times for diesel vehicles.

### SUMMARY OF THE INVENTION

The present invention includes a system and method for reducing vehicle idling time. The system includes override circuitry that provides an indication of whether or not an occupant is presently within the vehicle. A controller is responsive to the indication from the override circuitry, and if the vehicle is occupied, the controller disables a timer module that generates a signal for stopping the engine of the vehicle after expiration of the predetermined period of time.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a block diagram illustrating one embodiment of the present invention;

FIG. 2 is a flow diagram illustrating operation of the embodiment of FIG. 1; and

FIG. 3 is an example of door-opening detection circuitry; and

FIG. 4 is an exemplary embodiment of the override circuitry of the present invention

### DETAILED DESCRIPTION

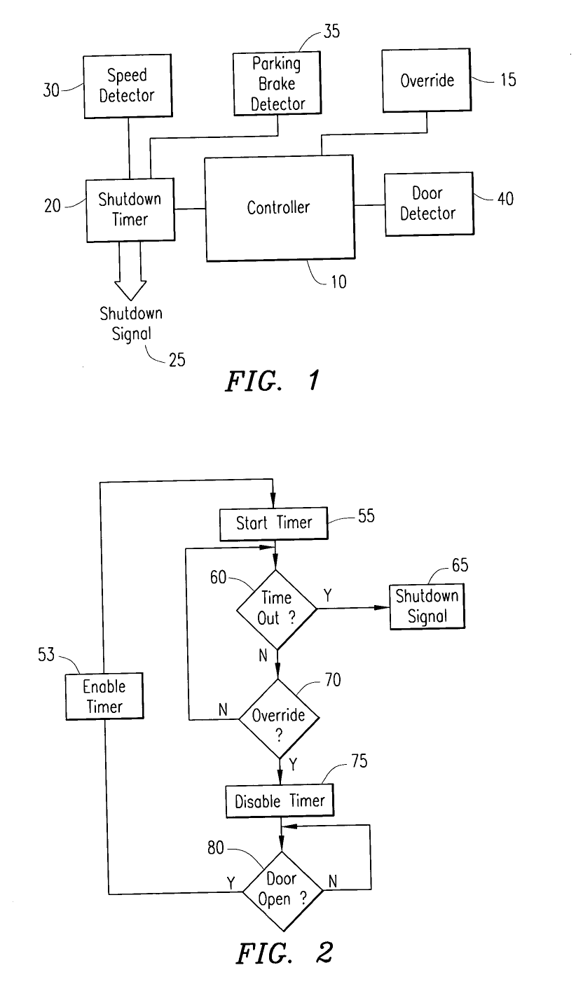

Referring now to the drawings, and more particularly to FIG. 1, there is illustrated one embodiment of the present invention for reducing vehicle idling time. Diesel engines are largely controlled by various electronic modules. One electronic module included within most diesel engines is the idle shutdown timer. The idle shutdown timer measures a selected period of time responsive to a determination that a vehicle has stopped and that the parking brake has been set. Most diesel engines have the idle shutdown timer module disabled. The present invention provides a manner for selectively activating and deactivating the idle shutdown timer module to reduce diesel engine idling time based upon occupancy of the vehicle.

A controller 10 is responsive to signals from override circuitry 15 and door detector 40. In response to inputs from these devices, the controller 10 enables and disables an idle shutdown timer 20. The idles shutdown timer 20 measures a predetermined time period to allow an engine to idle. Upon expiration of the idle shutdown timer 20, the shutdown timer generates a shutdown signal 25. The shutdown signal 25 is used to turn off the diesel engine of the vehicle. The speed detector 30 is interconnected with the speedometer circuitry of the vehicle in order in a well known manner to detect when the vehicle has stopped (0 mph). The parking brake detector 35 determines when the parking brake of the vehicle.

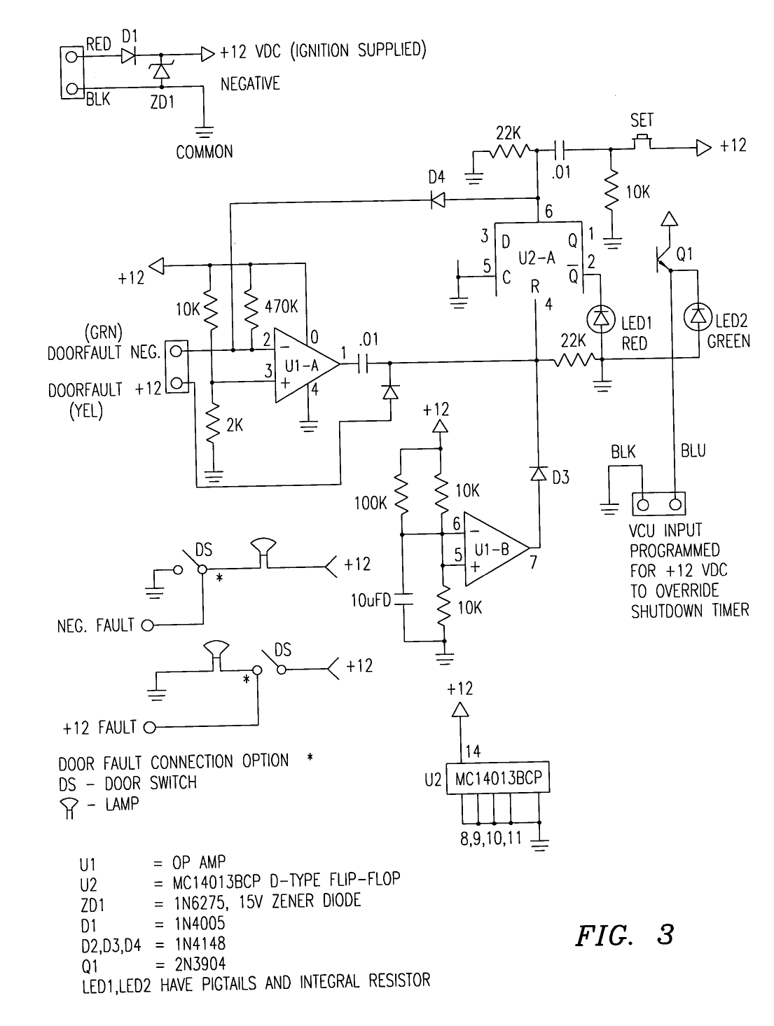

The door detector 40 detects any opening of the door of the vehicle. If the door of the vehicle is opened after the idle shutdown timer 20 has been disabled, the idle shutdown timer can be enabled such that the engine can be shut off if no driver is within the vehicle. The opening of the door is, of course, only one manner for determining the driver has left the vehicle. An exemplary circuit for the door detector is illustrated with respect to FIG. 3.

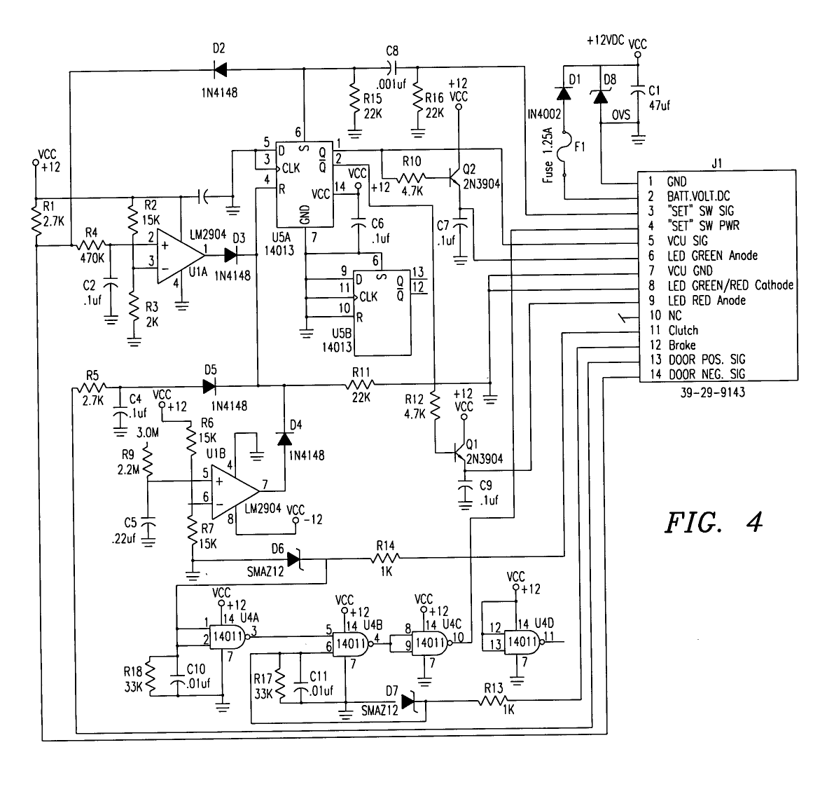

The override circuitry 15 enables the controller 10 to determine that the vehicle is occupied, disabling the idle shutdown timer 20 and preventing the generation of the shutdown signal 25. The override circuitry 15 detects whether or not the vehicle is occupied in any number of ways. This may be done through many different mechanisms such as infrared devices, imaging sensors, radar sensors, fingerprint scanners, retinal scanners, weight sensors, pressure switches, video, finger/palm print scanners, lasers, Pulse On technology, motion detector, or simple switches that require a human presence to actuate. The preferred embodiment of the invention described with respect to FIG. 1 utilizes a simple switch actuated by an occupant of the vehicle. The switch, of course, can be passive from the occupant standpoint or require an occupant input. Activation of the override circuitry 15 may also be actuated based upon a sequence of actions. For example, the driver could be required to push the brake, clutch and a switch in a particular order to override the idle shutdown timer. Any other number of combinations could be used. An example of the circuitry for activating the override circuitry 15 is illustrated in FIG. 4. This circuitry responds to a combination of the brake, the clutch and a switch to disable the shutdown timer 20. The override circuitry 15 may also enable the disabled idle shutdown timer 20, if it determines the vehicle is unoccupied.

Referring now to FIG. 2, there is illustrated the operation of the embodiment illustrated in FIG. 1. Once the necessary conditions are met, the idle shutdown timer 20 is actuated at step 55. After the idle shutdown timer 20 is actuated, inquiry step 60 monitors for timeout of the idle shutdown timer 20. Upon timeout of the idle shutdown timer 20, the shutdown signal 25 is generated at step 65 that is provided to the engine of the vehicle to cease vehicle idling. If inquiry step 60 does not detect a timeout of the shutdown timer, inquiry step 70 monitors for an input from the override circuitry 15. If no override is detected from the override circuitry 15, inquiry step 60 continues to monitor for completion of the idle shutdown timer 20. If inquiry step 70 detects an override input, the shutdown timer 20 is disabled at step 75. This allows the vehicle idle shutdown timer 20 to be overridden, enabling the engine to idle indefinitely. However, if inquiry step 80 determines that a door of the vehicle has opened responsive to input from the door detector 40 (or if the vehicle is unoccupied), the idle shutdown timer 20 is enabled at step 53 and restarted at step 55. This will allow idling of the vehicle to stop if someone opens a door and leaves the vehicle. Of course, the execution of the shutdown timer could again be overridden by the override circuitry which would be detected at inquiry step 70.

Use of the above described system and method accomplishes goals of reduced consumption fuel and reduced emissions from the vehicle. By detecting the occurrence of conditions indicating the vehicle is idling and detecting whether or not there is someone within the vehicle, the total idling time of the vehicle may be reduced.

The previous description is of a preferred embodiment for implementing the invention, and the scope of the invention should not necessarily be limited by this description. The scope of the present invention is instead defined by the following claims.

What is claimed is:

1. A method for reducing vehicle idle time, comprising the steps of:
detecting whether there is an occupant in the vehicle; and
disabling a timer that generates a signal to shut off an engine of the vehicle if an occupant is detected in the vehicle.

2. The method of claim 1, further including the steps of
detecting that the vehicle is unoccupied; and
enabling the timer responsive to detection that the vehicle is unoccupied if the timer is disabled.

3. The method of claim 1, further including the steps of:
detecting an opening of a door of the vehicle; and
enabling the timer responsive to detection of opening of the door of the vehicle if the timer is disabled.

4. A system for reducing idling time of a vehicle, comprising:
override circuitry for providing an indication of an occupant in the vehicle, and
a controller responsive to the indication from the override circuitry for disabling a timer module for generating a signal that stops an engine of the vehicle.

5. The system of claim 4, wherein the override circuitry further provides a second indicator that the vehicle is unoccupied.

6. The system of claim 5, wherein the controller further enables the timer module responsive to the second indicator if the timer module is disabled.

7. The system of claim 4, wherein the override circuitry further comprises at least one of an infrared device, an imaging sensor, a radar sensor, a fingerprint scanner, a retinal scanner, a weight sensor, a pressure switch, a video system, a palm print scanner, a laser system, a Pulse On system, a motion detector, or a switch.

8. The system of claim 4, further including:
circuitry for detecting an opening of a door of the vehicle; and
wherein said controller further enables said timer module responsive to detection of opening of the door of the vehicle if the time module is disabled.

9. A vehicle comprising;
an engine; and
a system for controlling an idling time of said engine, said system further comprising:
a timer module for timing a predetermined time period responsive to at least one input indicating the vehicle has stopped for activating and upon expiration of the predetermined time period for generating a signal for stopping the engine of the vehicle;
override circuitry for providing an indication of an occupant in the vehicle; and
a controller responsive to the indication from the override circuitry for disabling the timer module.

10. The system of claim 9, wherein the override circuitry further provides a second indicator that the vehicle is unoccupied.

11. The system of claim 10, wherein the controller further enables the timer module responsive to the second indicator if the timer module is disabled.

12. The vehicle of claim 9, wherein the override circuitry further comprises at least one of an infrared device, an imaging sensor, a radar sensor, a fingerprint scanner, a retinal scanner, a weight sensor, a pressure switch, a video system, a palm print scanner, a laser system, a Pulse On system, a motion detector, or a switch.

13. The vehicle of claim 10, further including:
circuitry for detecting an opening of a door of the vehicle; and
wherein said controller further enables said timer module responsive to detection of opening of the door of the vehicle if the timer module is disabled.

14. A system for reducing idling time of a vehicle, comprising:
a timer module for timing a predetermined time period responsive to at least one input indicating the vehicle has stopped for activating the timer and upon expiration of the predetermined time period for generating a signal for stopping an engine of the vehicle;
override circuitry for providing an indication of an occupant in the vehicle; and
a controller responsive to the indication from the override circuitry for disabling the timer module.

15. The system of claim 14, wherein the override circuitry further comprises at least one of an infrared device, an imaging sensor, a radar sensor, a fingerprint scanner, a retinal scanner, a weight sensor, a pressure switch, a video system, a palm print scanner, a laser system, a Pulse On system, a motion detector, or a switch.

16. The system of claim 14, further including:
circuitry for detecting an opening of a door of the vehicle; and
wherein said controller further enables said timer module responsive to detection of opening of the door of the vehicle if the time module is disabled.

17. The system of claim 14, wherein the override circuitry further provides a second indicator that the vehicle is unoccupied.

18. The system of claim 17, wherein the controller further enables the timer module responsive to the second indicator if the timer module is disabled.
